(19) United States
(12) Patent Application Publication
(10) Pub. No.: US 2026/0307731 A1
(43) Pub. Date: Oct. 8, 2026

(54) REAR VEHICLE BODY STRUCTURE

(71) Applicants: Hyundai Motor Company, Seoul (KR); Kia Corporation, Seoul (KR)

(72) Inventors: Hae Hoon LEE, Hwaseong-si (KR); Dong Wook Kim, Hwaseong-si (KR); Jin-oh Kim, Hwaseong-si (KR)

(21) Appl. No.: 19/402,514

(22) Filed: Nov. 26, 2025

(30) Foreign Application Priority Data
Apr. 2, 2025 (KR) 10-2025-0042550
May 26, 2025 (KR) 10-2025-0068154

(51) Int. Cl. B62D 25/08; B60R 22/34

(52) U.S. Cl. CPC B62D 25/08; B60R 22/34; B60R 2022/3402

(57) ABSTRACT

In an embodiment, a rear vehicle body structure is provided. The rear vehicle body structure includes a main rear pillar connectable to sides of a rear of a vehicle body and a sub-rear pillar connectable to the main rear pillar in a front-rear direction of the vehicle body. The main rear pillar includes a main closed cross-section in a vertical direction relative to the vehicle body and the sub-rear pillar includes a sub-closed cross-section in the vertical direction relative to the vehicle body.

### CROSS-REFERENCE TO RELATED APPLICATIONS

This application claims priority to and the benefit of Korean Patent Application No. 10-2025-0042550 filed with the Korean Intellectual Property Office on Apr. 2, 2025, and Korean Patent Application No. 10-2025-0068154 filed with the Korean Intellectual Property Office on May 26, 2025, the entire contents of which are incorporated herein by reference.

### TECHNICAL FIELD

The present disclosure relates to a rear vehicle body structure.

### BACKGROUND

Recently, the vehicle industry has been introducing a new concept of future mobility vision for realizing a dynamic, human-centered future city. One of these future mobility solutions is a purpose-based mobility (e.g., Purpose Built Vehicle; PBV).

PBV is an example of an electric vehicle (EV)-based environment-friendly mobility vehicle. These PBVs can provide users with a variety of customized services during their travel from departure to destination.

PBV can be manufactured in various shapes and sizes depending on the user's use case. For example, PBV can be used as a hailing or delivery type vehicle.

The PBV is equipped with a seat belt assembly mounted on the vehicle body as a safety component to prevent occupant accidents in the event of a collision or rollover.

In general, it is desirable to mount the seat belt assembly on a strong skeletal area of the vehicle body. The seat belt assembly may be mounted to a rear pillar (e.g., a D pillar) of the vehicle body, for example, at a position corresponding to a rear seat row of a hailing vehicle.

Such a seatbelt assembly can typically be mounted to a reinforcement bracket incorporated within the closed cross-section of the rear pillar. The seat belt assembly is mounted in a cantilevered configuration on the reinforcement bracket.

However, since the seat belt assembly is mounted in a cantilever shape on the reinforcement bracket, the mounting strength may be compromised by the mounting position of the seat belt assembly.

The information contained in this background section is intended to enhance understanding of the background of the disclosure and may include matters that are not conventional art already publicly known, available, or in use.

### SUMMARY

The present disclosure relates to a rear vehicle body structure, and more particularly, the present disclosure relates to a rear vehicle body structure adapted to mount a seat belt assembly to a rear pillar of the vehicle body.

Embodiments of the present disclosure provide a rear vehicle body structure that provides mounting strength for a seat belt assembly to a rear pillar.

A rear vehicle body structure, according to example embodiments, may include a main rear pillar provided on both rear sides of a vehicle body and having a main closed cross-section formed along the vertical direction of the vehicle body, and a sub-rear pillar connected to the main rear pillar along the front-rear direction of the vehicle body and having a sub-closed cross-section formed along the vertical direction of the vehicle body.

The sub-rear pillar may be connected to a quarter assembly along the front-rear direction of the vehicle body.

The rear vehicle body structure may further include a seat belt mount connected to the main rear pillar and the sub-rear pillar.

A rear vehicle body structure, according to example embodiments, may include a main rear pillar, which is provided on both sides of the rear of the vehicle body and has a main closed cross-section formed along the vertical direction, a sub-rear pillar connected to the main rear pillar along the front-rear direction of the vehicle body and having a sub-closed cross-section formed along the vertical direction, a seat belt mounting bracket connected to the sub-rear pillar and connected to the main rear pillar, and a seat belt reinforcement bracket connected to the main rear pillar.

The main rear pillar may include a main pillar outer member, and a main pillar inner member connected to the rear end portion of the main pillar outer member.

The sub-rear pillar may include a side wall portion extending from the rear end portion of the main pillar outer member, and a sub-pillar inner member connected to the main pillar inner member.

The main closed cross-section may be formed between the rear end portion of the main pillar outer member and the main pillar inner member.

The sub-closed cross-section may be formed between the side wall portion of the main pillar outer member and the sub-pillar inner member.

The main closed cross-section and the sub-closed cross-section may be connected along the front-back direction of the vehicle body through a connecting section.

The sub-closed cross-section may be formed between the main pillar outer member and the sub-pillar inner member, and the sub-pillar inner member may include a pillar forming portion formed in the inner direction.

The seat belt mounting bracket may include a bracket main body connected to a pillar forming portion formed on the sub-pillar inner member, and a pillar connecting portion extending from the bracket main body and connecting the main rear pillar and the sub-rear pillar.

The bracket main body may include a mounting forming portion formed in an inner direction to form a mounting closed cross-section at a position corresponding to the sub-closed cross-section.

The pillar connecting portion may be connected to a combining portion of the main pillar outer member, the main pillar inner member, and the sub-pillar inner member.

The seat belt reinforcement bracket may be connected to the main pillar inner member between the main pillar outer member and the main pillar inner member.

The seat belt reinforcement bracket may be provided with an ‘L’ cross-section shape corresponding to the cross-section shape of the main pillar inner member.

The seat belt assembly may include a mounting bracket connected to the seat belt mounting bracket and the seat belt reinforcement bracket, and a seat belt retractor is secured to the mounting bracket.

The mounting bracket may include a base portion connected to the seat belt mounting bracket, and a bridge portion extending from the base portion and connected to the seat belt reinforcement bracket.

The main rear pillar may further include at least one bulkhead connected between the main pillar outer member and the main pillar inner member.

According to the rear vehicle body structure according to the disclosed embodiment, structural strength of the rear part of the vehicle body can be secured, and mounting strength of the seat belt assembly can be secured.

In addition, any effects that can be obtained or expected from the disclosed example embodiments are disclosed directly or implicitly in the detailed description. That is, various effects expected according to the disclosed example embodiments will be disclosed in the detailed description that follows.

### BRIEF DESCRIPTION OF THE DRAWINGS

These drawings are intended for reference in describing example embodiments disclosed, and therefore the technical ideas of the disclosed embodiments should not be construed as limited to the accompanying drawings.

FIG. 1 is a perspective view illustrating a rear vehicle body structure according to an embodiment of the present disclosure.

FIGS. 2 and 3 are perspective views illustrating a portion of a rear vehicle body structure according to an embodiment of the present disclosure.

FIG. 4 is a side view illustrating a portion of a rear vehicle body structure according to an embodiment of the present disclosure.

FIGS. 5 and 6 are exploded perspective views illustrating a portion of a rear vehicle body structure according to an embodiment of the present disclosure.

FIG. 7 is a cross-sectional view along line A-A of FIG. 4.

FIG. 8 is a cross-sectional view along the B-B line of FIG. 4.

FIG. 9 is a drawing illustrating a seat belt mount applied to a rear vehicle body structure according to an embodiment of the present disclosure.

FIG. 10 is a cross-sectional view along the C-C line of FIG. 9.

FIG. 11 is a cross-sectional view along line D-D of FIG. 9.

FIGS. 12A and 12B are drawings illustrating a seat belt mounting bracket applied to a rear vehicle body structure according to an embodiment of the present disclosure.

FIGS. 13A and 13B are drawings illustrating a seat belt reinforcement bracket applied to a rear vehicle body structure according to an embodiment of the present disclosure.

The drawings referenced above are not necessarily drawn to scale, but should be understood as presenting simplified representations of various features that illustrate the basic principles of the example embodiments. For example, certain design features of the example embodiments, including specific dimensions, direction, position, and shape, will be determined in part by the particular intended application and usage environment.

### DETAILED DESCRIPTION OF THE ILLUSTRATIVE EMBODIMENTS

Hereinafter, with reference to the attached drawings, embodiments of the present disclosure will be described in detail so that a person having ordinary skill in the art to which the present disclosure pertains can easily practice the present disclosure. As those skilled in the art would realize, the described embodiments may be modified in various different ways, all without departing from the spirit or scope of the present disclosure.

The terminology used herein is for the purpose of describing particular embodiments only and is not intended to limit the present disclosure. As used herein, the singular forms are intended to include the plural forms as well, unless the context clearly indicates otherwise.

It should also be understood that the terms “comprise” and/or “include” as used herein indicate the presence of stated features, integers, steps, operations, elements and/or components, but do not preclude the presence or addition of one or more other features, integers, steps, operations, components, and/or groups thereof. As used herein, the term 'and/or' includes any and all combinations of one or more of the associated listed items.

In the present disclosure, the term ‘connected’ indicates a physical relationship between two components where the components are directly connected to each other by welding, SPR (Self Piercing Rivet), FDS (Flow Drill Screw), structural adhesive, etc., or indirectly connected through one or more intermediate components.

As used herein, 'vehicle', 'vehicular', 'automotive' or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs (Purpose Built Vehicles), hydrogen-powered vehicles and other alternative fuel vehicles (e.g., other than petroleum fuel derived from resources).

Hereinafter, embodiments of the present disclosure will be described in detail with reference to the attached drawings.

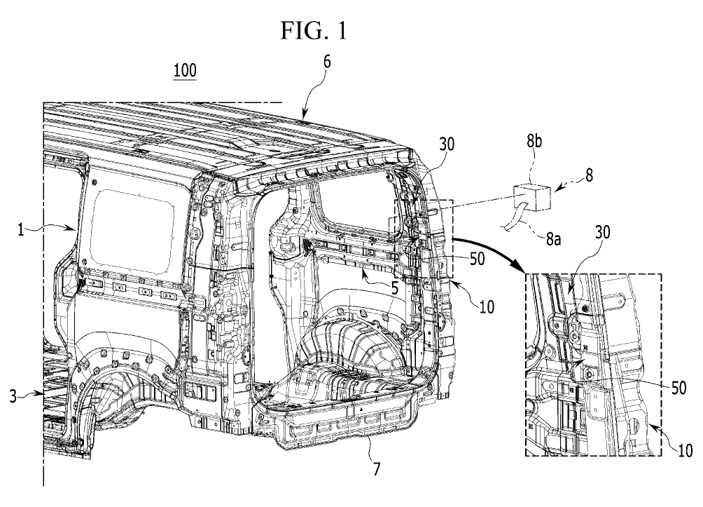

FIG. 1 is a perspective view illustrating a rear vehicle body structure according to an embodiment of the present disclosure.

Referring to FIG. 1, the rear vehicle body structure 100 can be applied, for example, to the vehicle body of a purpose-based mobility vehicle (Purpose Built Vehicle: hereinafter referred to as ‘PBV’).

The PBV may be utilized as an electric vehicle-based life module vehicle that provides various customized services to users during the time they travel from the departure point to the destination.

In one example, the PBV may be manufactured as a one box type design with a wide vehicle interior space. The PBV may also apply facing-type seats to the vehicle interior space. The vehicle body of the PBV may be manufactured in various shapes and sizes depending on the purpose of use of the PBV.

The vehicle body of the PBV may be utilized as a variety of vehicle types, such as a hailing vehicle as a means of transporting occupants, a delivery vehicle for transporting goods, and a special vehicle such as an ambulance.

In the present disclosure, the reference direction for describing the components below may be set as the vehicle body front-back direction (e.g., front-rear direction, vehicle body length direction, or longitudinal direction), vehicle width direction (e.g., lateral direction or left-right direction), and vertical direction (e.g., height direction) relative to the vehicle body or with the vehicle body as reference.

In the present disclosure, the “top,” “upper,” or “upper face” of a component refers to an end, section, or face of the component that is relatively higher in the drawing, and the “bottom,” “lower,” or “lower face” of a component refers to an end, section, or face of the component that is relatively lower in the drawing.

In the present disclosure, the term “end” of a component (e.g., one end, the other end, or both ends, etc.) refers to an end of the component in any one direction, and the term “end portion” of a component (e.g., one end portion, the other end portion, both end portions, the front end portion, or the rear end portion, etc.) refers to a portion of the component that includes that end.

The vehicle body of the PBV may include a side structure 1 arranged on each side along the vehicle width direction, and a roof structure 6 connected to the upper portion of the side structure 1.

The side structure 1 may be placed on each side of the floor structure 3 along the vehicle width direction. The side structure 1 may be equipped with a vehicle door, such as a sliding door or swing door. However, depending on the vehicle type, the door may not be mounted on the side structure 1. The side structure 1 may or may not have a window mounted on it depending on the vehicle type.

The roof structure 6 may be connected to the top of the side structure 1. The roof structure 6 may include a large area of roof panels. The roof structure 6 may also include a high roof module.

A seat belt assembly 8 may be mounted on side structure 1. The seat belt assembly 8 may, in one example, be mounted at a position corresponding to a row of rear seats within the vehicle.

The seat belt assembly 8 may include a seat belt retractor 8b for winding or releasing the seat belt 8a. The configuration and operation of the seat belt assembly 8 are obvious to those skilled in the art, so a detailed description is omitted.

The rear vehicle body structure 100, according to an embodiment, is configured to mount the seat belt assembly 8 on the rear portion of the side structure 1. The rear vehicle body structure 100, according to an embodiment, provides a structure capable of reinforcing the mounting strength of the seat belt assembly 8.

The rear vehicle body structure 100, according to an embodiment, may include a main rear pillar 10, a sub-rear pillar 30, and a seat belt mount 50.

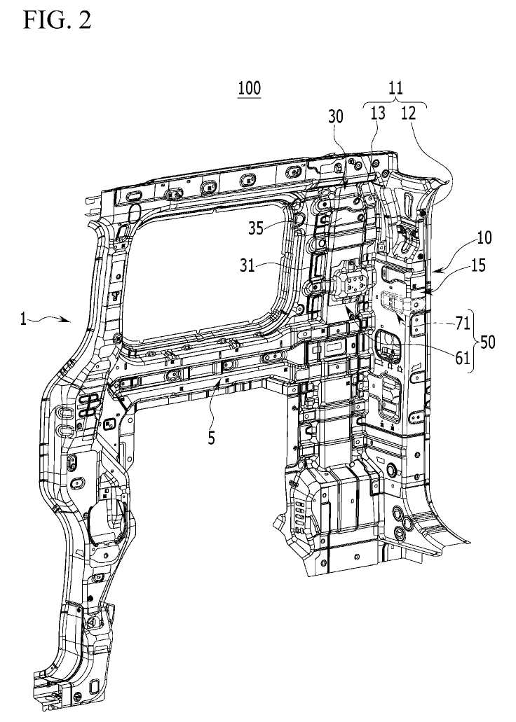

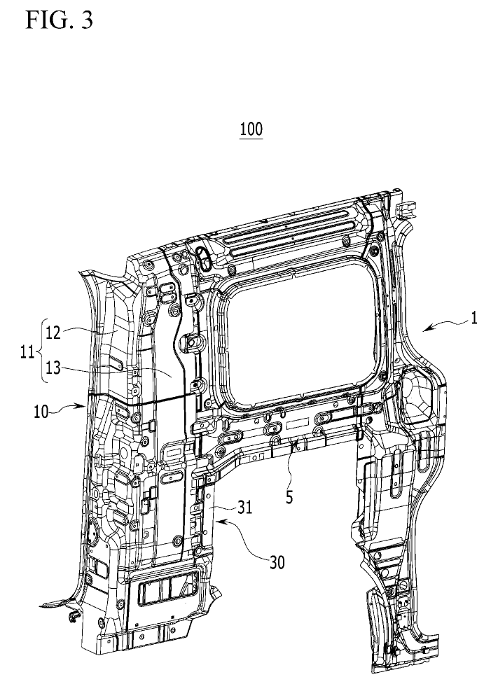

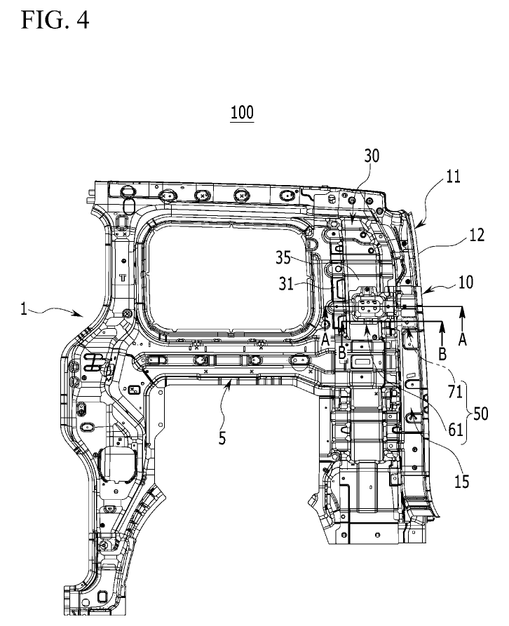

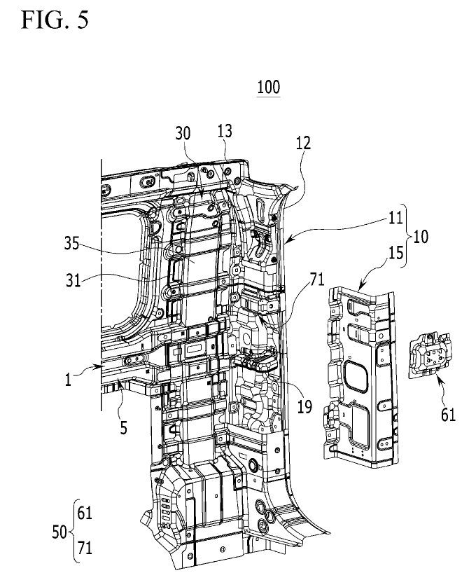

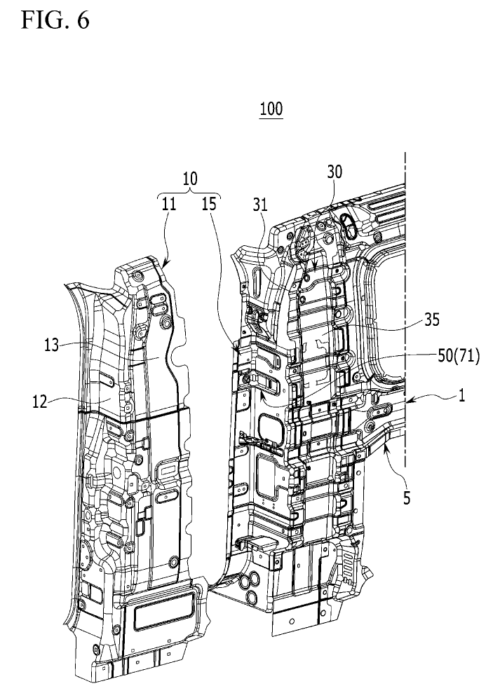

FIGS. 2 and 3 are perspective views illustrating a portion of a rear vehicle body structure according to an embodiment. FIG. 4 is a side view illustrating a portion of a rear vehicle body structure according to an embodiment, and FIGS. 5 and 6 are exploded perspective views illustrating a portion of a rear vehicle body structure according to an embodiment.

Referring to FIGS. 2-6, the main rear pillar 10 and the sub-rear pillar 30, according to an embodiment, may be provided in the rear portion of the side structure 1.

The main rear pillar 10 and the sub-rear pillar 30 are connected to each other and may be connected to a quarter assembly 5 of the side structure 1 along the front-rear direction of the vehicle body.

The main rear pillar 10 and the sub-rear pillar 30 may be connected to a roof structure 6 and a back panel 7 as shown in FIG. 1 to form an opening flange in the rear portion of the vehicle body. The opening flange may be used to mount a rear door, for example a twin swing door.

In an embodiment, the main rear pillar 10 may include a main pillar outer member 11 and a main pillar inner member 15. The main pillar outer member 11 may be referred to as a main pillar outer part and the main pillar inner member may be referred to as a main pillar inner part.

The main pillar outer member 11, as shown in FIGS. 3 and 6, may be arranged along the vertical direction at the rear end of the side structure 1.

The main pillar outer member 11 may include a rear end portion 12 and a side wall portion 13 extending forward from the rear end portion 12. The main pillar outer member 11 may be provided in the cross-section shape of ‘L’.

The main pillar inner member 15 may be disposed on the inner side of the main pillar outer member 11. The main pillar inner member 15 may be connected to the rear end portion 12 of the main pillar outer member 11.

The main pillar inner member 15 may be connected to the side wall portion 13 of the main pillar outer member 11 and the sub-rear pillar 30. The main pillar inner member 15 may be provided in the cross-section shape of ‘L’.

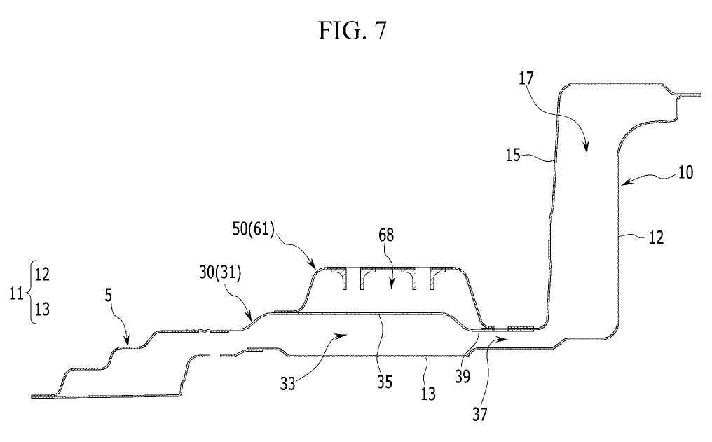

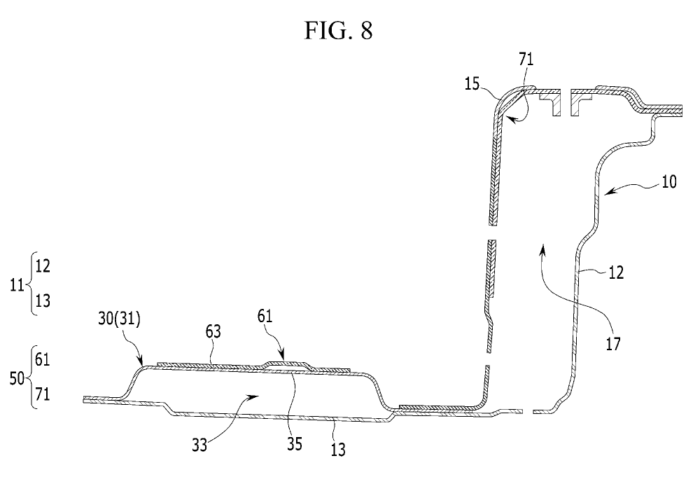

FIG. 7 is a cross-sectional view along line A-A of FIG. 4, and FIG. 8 is a cross-sectional view along the B-B line of FIG. 4.

As shown in FIGS. 7 and 8, a main closed cross-section 17 may be formed along the vertical direction between the rear end portion 12 of the main pillar outer member 11 and the main pillar inner member 15.

The main rear pillar 10 may include at least one bulkhead 19 (see FIG. 5). The at least one bulkhead 19 is configured to reinforce the strength of the main rear pillar 10. At least one bulkhead 19 may be connected between the main pillar outer member 11 and the main pillar inner member 15.

In an embodiment, the sub-rear pillar 30 may be connected to the main rear pillar 10 along the vehicle body front-back direction. The sub-rear pillar 30 may be connected to the quarter assembly 5 along the front-rear direction of the vehicle body.

The sub-rear pillar 30 may include a sub-pillar inner member 31. The sub-pillar inner member 31 may be disposed along the vertical direction in front of the main rear pillar 10. The sub-pillar inner member 31 may be connected to a side wall portion 13 of the main pillar outer member 11 and the main pillar inner member 15. The sub-pillar inner member 31 may be referred to as a sub-pillar inner part.

The side wall portion 13 of the main pillar outer member 11, which is connected to the sub-pillar inner member 31, may be provided as the outer member of the sub-rear pillar 30. The side wall portion 13 of the main pillar outer member 11 and the sub-pillar inner member 31, which are connected to each other, may be connected to the quarter assembly 5 along the front-rear direction of the vehicle body.

A sub-closed cross-section 33 may be formed between the side wall portion 13 of the main pillar outer member 11 and the sub-pillar inner member 31. The sub-closed cross-section 33 may be disposed along the vertical direction in front of the main rear pillar 10.

The sub-pillar inner member 31 includes a pillar forming portion 35 formed in the inner direction to form the sub-closed cross-section 33. The pillar forming portion 35 may be referred to as a pillar portion.

The pillar forming portion 35 may be formed along the vertical direction in the sub-pillar inner member 31. The pillar forming portion 35 may form a sub-closed cross-section 33 between the side wall portion 13 of the main pillar outer member 11 and the sub-pillar inner member 31, as the side wall portion 13 of the main pillar outer member 11 and the sub-pillar inner member 31 are connected to each other.

The main closed cross-section 17 and the sub-closed cross-section 33 may be connected along the forward-rear direction of the vehicle body by connecting section 37, as shown in FIG. 7.

The connecting section 37 may be formed by a connecting forming portion 39 connected to the pillar forming portion 35 in the sub-pillar inner member 31. The connecting forming portion 39 may be connected to the main pillar inner member 15.

The connecting section 37 may be formed between the connected portion of the main pillar inner member 15 and the sub-pillar inner member 31 and the side wall portion 13 of the main pillar outer member 11. The connecting section 37 may be connected to the main closed cross-section 17 and sub-closed cross-section 33 along the front-back direction of the vehicle body.

Referring to FIGS. 2-6, in an embodiment, the seat belt mount 50 is configured to mount the seat belt assembly 8 as shown in FIG. 1 to the main rear pillar 10 and the sub-rear pillar 30.

The seat belt mount 50 may be connected to the main rear pillar 10 and the sub-rear pillar 30.

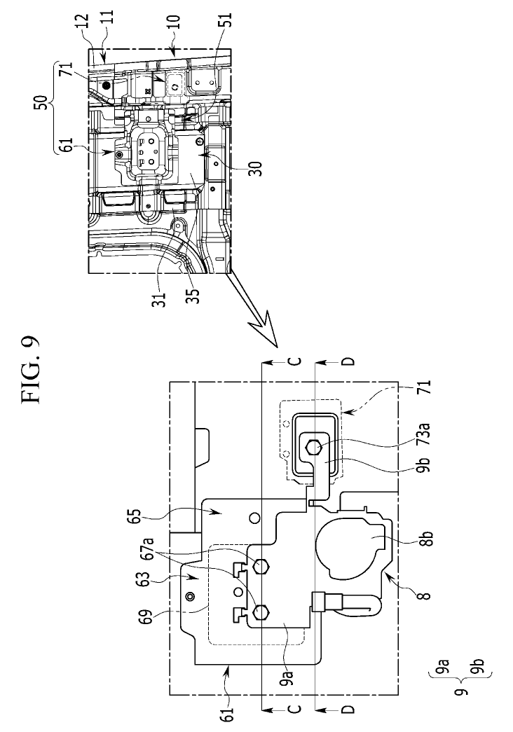

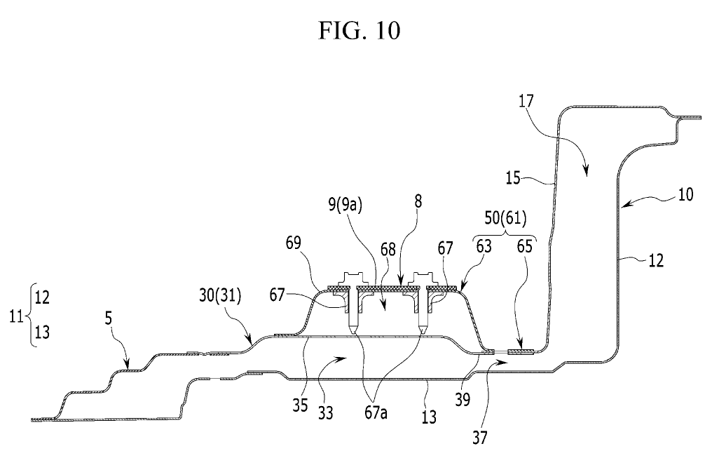

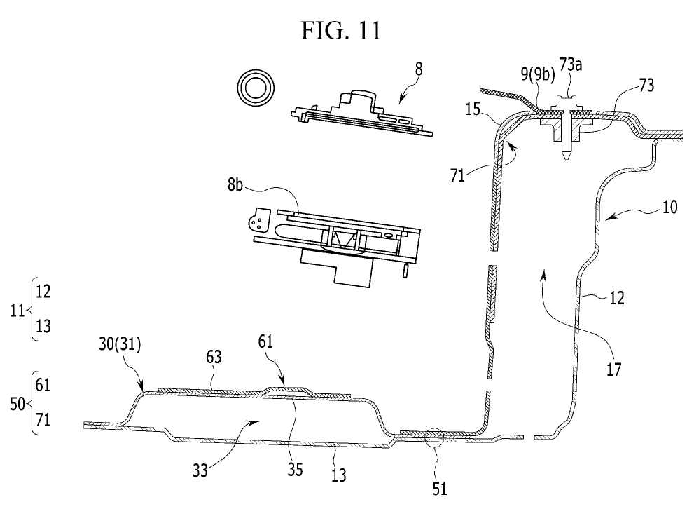

FIG. 9 is a drawing illustrating a seat belt mount applied to a rear vehicle body structure according to an embodiment. FIG. 10 is a cross-sectional view along the C-C line of FIG. 9, and FIG. 11 is a cross-sectional view along line D-D of FIG. 9.

Referring to FIGS. 9-11, the seat belt mount 50 according an embodiment may include a seat belt mounting bracket 61 and a seat belt reinforcement bracket 71.

The seat belt mounting bracket 61 is connected to the sub-rear pillar 30 and may be connected to the main rear pillar 10 along the front-rear direction of the vehicle body.

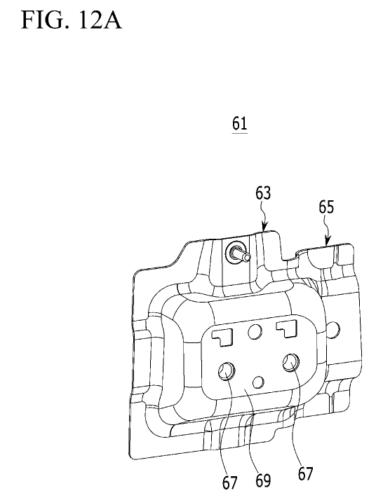

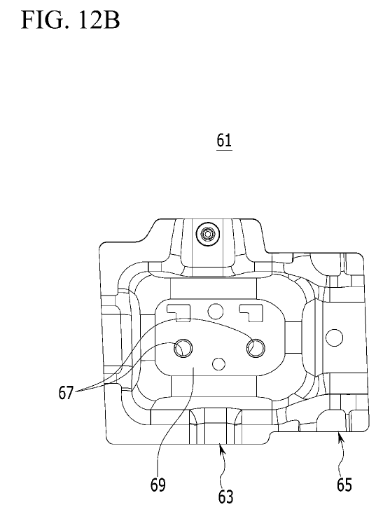

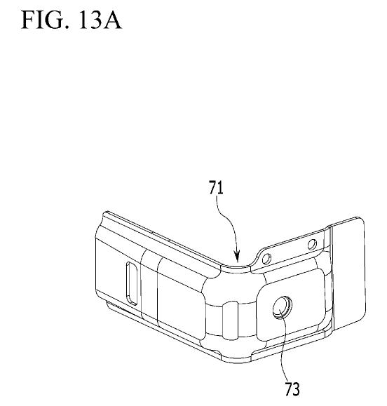

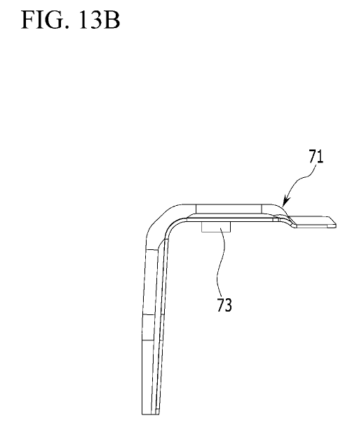

FIGS. 12A-12B are drawings illustrating a seat belt mounting bracket applied to a rear vehicle body structure according to an embodiment. FIGS. 13A and 13B are drawings illustrating a seat belt reinforcement bracket applied to a rear vehicle body structure according to an embodiment.

The seat belt mounting bracket 61 may include a bracket main body 63 and a pillar connecting portion 65, as illustrated in FIGS. 12A and 12B. The pillar connecting portion 65 may be referred to as a pillar connector.

The bracket main body 63 may be connected to the pillar forming portion 35 of the sub-pillar inner member 31 at a position corresponding to the sub-closed cross-section 33.

The bracket main body 63 includes a mounting forming portion 69 formed in an inner direction to form a mounting closed cross-section 68 at a position corresponding to the sub-closed cross-section 33. The mounting forming portion 69 may be referred to as a mounting portion.

The mounting closed cross-section 68 may be formed between the pillar forming portion 35 and the mounting forming portion 69. The sub-closed cross-section 33 and the mounting closed cross-section 68 may be provided as a double closed cross-section partitioned along the vehicle width direction.

The mounting forming portion 69 of the bracket main body 63 is connected with at least one first weld nut 67.

The pillar connecting portion 65 is configured to connect the main rear pillar 10 and the sub-rear pillar 30 along the front-rear direction of the vehicle body. The pillar connecting portion 65 may be formed to extend rearward from the bracket main body 63.

The pillar connecting portion 65 may be connected to a combining portion 51 of the main pillar outer member 11, the main pillar inner member 15 and the sub-pillar inner member 31.

The seat belt reinforcement bracket 71 is configured to reinforce the frame strength of the main rear pillar 10 and the mounting strength of the seat belt assembly 8.

The seat belt reinforcement bracket 71 is provided separately from the seat belt mounting bracket 61 and may be connected to the main rear pillar 10.

The seat belt reinforcement bracket 71 may be disposed between the rear end portion 12 of the main pillar outer member 11 and the main pillar inner member 15. The seat belt reinforcement bracket 71 may be connected to the rear end portion 12 of the main pillar outer member 11 and the inner surface of the main pillar inner member 15.

The seat belt reinforcement bracket 71 may be provided with an ‘L’ cross-section shape corresponding to the cross-section shape of the main pillar inner member 15, as shown in FIGS. 13A and 13B. The seat belt reinforcement bracket 71 is connected with at least one second weld nut 73.

Referring to FIGS. 9-11, the seat belt assembly 8 mentioned above may be mounted on the seat belt mounting bracket 61 and the seat belt reinforcement bracket 71 of the seat belt mount 50.

The seat belt assembly 8 may include a mounting bracket 9. The mounting bracket 9 may be connected to the seat belt mounting bracket 61 and the seat belt reinforcement bracket 71.

The mounting bracket 9 may be used to secure the seat belt retractor 8b. The mounting bracket 9 may include a base portion 9a and a bridge portion 9b.

The base portion 9a may be connected to the seat belt mounting bracket 61. The base portion 9a may be connected to the mounting forming portion 69 of the bracket main body 63. The base portion 9a may be connected to the mounting forming portion 69 by at least one bolt 67a. The bolt 67a may be engaged with at least one first weld nut 67 connected to the bracket main body 63.

The bridge portion 9b extends from the base portion 9a and may be connected to the seat belt reinforcement bracket 71. The bridge portion 9b may be connected to the seat belt reinforcement bracket 71 by at least one bolt 73a. The bolt 73a may engage at least one second weld nut 73 secured to the seat belt reinforcement bracket 71.

Hereinafter, the operation of the rear vehicle body structure 100, according to an embodiment, configured as described above will be described in detail with reference to FIGS. 1-13B.

In an embodiment, the main rear pillar 10 and the sub-rear pillar 30 may be provided connected to each other along the front-rear direction of the vehicle body in the rear portion of the side structure 1.

The main rear pillar 10 includes the main pillar outer member 11 and the main pillar inner member 15, which are connected to each other. The main rear pillar 10 includes the main closed cross-section 17 formed between the rear end portion 12 of the main pillar outer member 11 and the main pillar inner member 15.

The sub-rear pillar 30 is connected to the main rear pillar 10 along the front-rear direction of the vehicle body, and may be connected to the quarter assembly 5 along the front-rear direction of the vehicle body. The sub-rear pillar 30 includes the side wall portion 13 of the main pillar outer member 11 and sub-pillar inner member 31 connected to the main pillar inner member 15. The sub-rear pillar 30 includes the sub-closed cross-section 33 formed between the side wall portion 13 of the main pillar outer member 11 and the sub-pillar inner member 31 by the pillar forming portion 35 provided on the sub-pillar inner member 31. The main closed cross-section 17 and the sub-closed cross-section 33 may be connected along the front-back direction of the vehicle body by the connecting section 37.

The seat belt mounting bracket 61 of the seat belt mount 50 is connected to the sub-rear pillar 30 and is connected to the main rear pillar 10 along the front-rear direction of the vehicle body. The seat belt mounting bracket 61 includes the bracket main body 63 and the pillar connecting portion 65.

The bracket main body 63 may be connected to the pillar forming portion 35 of the sub-pillar inner member 31. The pillar connecting portion 65 may be connected to the combining portion 51 of the main pillar outer member 11, the main pillar inner member 15 and the sub-pillar inner member 31. The mounting closed cross-section 68 may be formed between the mounting forming portion 69 provided in the bracket main body 63 and the pillar forming portion 35. The mounting closed cross-section 68 may be disposed in a position corresponding to the sub-closed cross-section 33.

The seat belt reinforcement bracket 71 of the seat belt mount 50 is connected to the rear end portion 12 of the main pillar outer member 11 and the inner surface of the main pillar inner member 15, separately from the seat belt mounting bracket 61.

The seat belt assembly 8 may be mounted on the seat belt mounting bracket 61 and the seat belt reinforcement bracket 71.

The seat belt assembly 8 includes the mounting bracket 9 engaged with the seat belt mounting bracket 61 and the seat belt reinforcement bracket 71, and the seat belt retractor 8b secured to the mounting bracket 9.

The mounting bracket 9 includes the base portion 9a and the bridge portion 9b extending from the base portion 9a. The base portion 9a may be engaged with the bracket main body 63 of the seat belt mounting bracket 61. The bridge portion 9b may engage the seat belt reinforcement bracket 71.

According to the rear vehicle body structure 100, the main rear pillar 10 having the main closed cross-section 17 and the sub-rear pillar 30 having the sub-closed cross-section 33 may be provided.

According to an embodiment, the main rear pillar 10 and the sub-rear pillar 30 may be primarily connected through the seat belt mounting bracket 61.

According to an embodiment, the seat belt reinforcement bracket 71 is connected to the main rear pillar 10.

According to an embodiment, the mounting bracket 9 of the seat belt assembly 8 is bi-directionally connected to the seat belt mounting bracket 61 and the seat belt reinforcement bracket 71. The main rear pillar 10 and the sub-rear pillar 30 may be secondarily connected through the mounting bracket 9.

The main closed cross-section 17 and the sub-closed cross-section 33 are connected to each other. The mounting bracket 9 of the seat belt assembly 8 may be connected to the main rear pillar 10 and the sub-rear pillar 30 in a bridge form or a simply supported beam form.

According to an embodiment, since the cross-sections of the main rear pillar 10 and the sub-rear pillar 30 are connected to each other, structural rigidity of the rear portion of the vehicle body may be secured.

According to an embodiment, the seat belt assembly 8 is mounted in a bridge form on the multi-member of the main rear pillar 10 and the sub-rear pillar 30 that are connected to each other, so that the mounting strength of the seat belt assembly 8 may be secured.

While this disclosure has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

What is claimed is:

1. A rear vehicle body structure comprising:
a main rear pillar connectable to sides of a rear of a vehicle body, the main rear pillar having a main closed cross-section in a vertical direction relative to the vehicle body; and
a sub-rear pillar connectable to the main rear pillar in a front-rear direction of the vehicle body, the sub-rear pillar having a sub-closed cross-section in the vertical direction relative to the vehicle body.

2. The rear vehicle body structure of claim 1, wherein the sub-rear pillar is connectable to a quarter assembly in the front-rear direction of the vehicle body.

3. The rear vehicle body structure of claim 1, further comprising:
a seat belt mount connectable to the main rear pillar and the sub-rear pillar.

4. A rear vehicle body structure comprising:
a main rear pillar arranged on sides of a rear of a vehicle body, the main rear pillar having a main closed cross-section in a vertical direction relative to the vehicle body;
a sub-rear pillar connected to the main rear pillar in a front-rear direction of the vehicle body, the sub-rear pillar having a sub-closed cross-section in the vertical direction relative to the vehicle body;
a seat belt mounting bracket connected to the sub-rear pillar and connected to the main rear pillar; and
a seat belt reinforcement bracket connected to the main rear pillar.

5. The rear vehicle body structure of claim 4, wherein the main rear pillar comprises:
a main pillar outer part; and
a main pillar inner part connected to a rear end of the main pillar outer part.

6. The rear vehicle body structure of claim 5, wherein the main rear pillar further comprises at least one bulkhead connected between the main pillar outer part and the main pillar inner part.

7. The rear vehicle body structure of claim 5, wherein the sub-rear pillar comprises:
a side wall extending from the rear end of the main pillar outer part; and
a sub-pillar inner part connected to the main pillar inner part.

8. The rear vehicle body structure of claim 7, wherein:
the main closed cross-section is arranged between the rear end of the main pillar outer part and the main pillar inner part; and
the sub-closed cross-section is arranged between the side wall of the main pillar outer part and the sub-pillar inner part.

9. The rear vehicle body structure of claim 8, wherein the main closed cross-section and the sub-closed cross-section are connected in the front-rear direction of the vehicle body via a connector.

10. The rear vehicle body structure of claim 7, wherein:
the sub-closed cross-section is arranged between the main pillar outer part and the sub-pillar inner part; and
the sub-pillar inner part comprises a pillar portion arranged in an inner direction.

11. The rear vehicle body structure of claim 7, wherein the seat belt mounting bracket comprises:
a bracket main body connected to a pillar portion arranged on the sub-pillar inner part; and
a pillar connector extending from the bracket main body to connect the main rear pillar and the sub-rear pillar.

12. The rear vehicle body structure of claim 11, wherein the bracket main body comprises a mounting portion arranged in an inner direction to form a mounting closed cross-section at a position corresponding to the sub-closed cross-section.

13. The rear vehicle body structure of claim 11, wherein the pillar connector is connected to a combining portion of the main pillar outer part, the main pillar inner part, and the sub-pillar inner part.

14. The rear vehicle body structure of claim 7, wherein the seat belt reinforcement bracket is connected to the main pillar inner part between the main pillar outer part and the main pillar inner part.

15. The rear vehicle body structure of claim 14, wherein the seat belt reinforcement bracket is provided with an ‘L’ cross-section shape corresponding to a shape of a cross-section of the main pillar inner part.

16. The rear vehicle body structure of claim 4, further comprising a seat belt assembly that comprises:
a mounting bracket connected to the seat belt mounting bracket and the seat belt reinforcement bracket; and
a seat belt retractor secured to the mounting bracket.

17. The rear vehicle body structure of claim 16, wherein the mounting bracket comprises:
a base connected to the seat belt mounting bracket; and
a bridge extending from the base and connected to the seat belt reinforcement bracket.

18. A method of assembling a rear vehicle body structure comprising:
providing a main rear pillar on sides of a rear of a vehicle body, the main rear pillar having a main closed cross-section in a vertical direction relative to the vehicle body;
connecting a sub-rear pillar to the main rear pillar in a front-rear direction of the vehicle body, the sub-rear pillar having a sub-closed cross-section in the vertical direction relative to the vehicle body;
connecting a seat belt mounting bracket to the sub-rear pillar and the main rear pillar; and
connecting a seat belt reinforcement bracket to the main rear pillar.

19. The method of claim 18, further comprising:
connecting, via a connector, the main closed cross-section of the main rear pillar and the sub-closed cross-section of the sub-rear pillar in the front-rear direction of the vehicle body;
connecting a bracket main body of the seat belt mounting bracket to a pillar portion arranged on a sub-pillar inner part of the sub-rear pillar;
connecting a pillar connector of the bracket main body to the main rear pillar and the sub-rear pillar, the pillar connector extending from the bracket main body; and
connecting the pillar connector to a combining portion of a main pillar outer part of the main rear pillar, a main pillar inner part of the main rear pillar, and the sub-pillar inner part of the sub-rear pillar.

20. The method of claim 18, further comprising:
connecting the seat belt reinforcement bracket to a main pillar inner part between a main pillar outer part and the main pillar inner part;
connecting a mounting bracket of a seat belt assembly to the seat belt mounting bracket and the seat belt reinforcement bracket; and
connecting a seat belt retractor to the mounting bracket.
